(19) United States
(12) Patent Application Publication
(10) Pub. No.: US 2012/0216826 A1
(43) Pub. Date: Aug. 30, 2012

(54) DENTAL CORD DISPENSER

(76) Inventor: Paul Porteous, Tousand Oaks, CA (US)

(21) Appl. No.: 13/220,604

(22) Filed: Aug. 29, 2011

Related U.S. Application Data
(60) Provisional application No. 61/378,104, filed on Aug. 30, 2010.

(51) Int. Cl. A61C 15/04

(52) U.S. Cl. 132/325

(57) ABSTRACT

This invention relates to an apparatus for dispensing a cord and comprises a housing having a cavity arranged to hold the cord. The housing also has a top cover and a bottom cover to enclose the cord. The dispenser further comprises a knob, handle or button on the dispenser, for example on the top cover or side for use in feeding the cord from the dispenser, an aperture that provides an outlet for the retraction cord to exit the housing, and a cutter near the aperture to cut the dispensed cord.

This application claims the benefit of priority to U.S. Provisional Application No. 61/378,104, filed on Aug. 30, 2010.

### BACKGROUND

1. Field of the Invention

This invention relates to dental devices, and more particular to an apparatus for dispensing dental cords, such as but not limited to, gingival retraction cords.

2. Description of the Related Art

In dental treatment, it is often necessary to retract gingival tissue from a tooth in order to prepare the patient for taking impressions, setting crowns, or effecting restorations. It is important to make an accurate impression of the tooth when constructing artificial crowns to ensure that the crown remains properly secured to the tooth for an extended period of time. It is particularly important to make an accurate impression of the tooth in the area at or below the gingival margin. Failure to take an accurate impression can result in a poorly-formed or deficient prosthesis, particularly at the gingival margin. Premature failure of a crown is often due to poor marginal detail in the impression used to fabricate the crown. Retractions of the gingival tissue are typically performed using gingival retraction cords, for example, cords fabricated of cotton which may be impregnated with a therapeutic preparation.

A commonly employed conventional method of using retraction cord comprises removing the retraction cord from a bulk container, cutting the retraction cord to an appropriate length, wrapping the length of retraction cord around the base of the tooth several times, and then manually forcing the retraction cord into the sulcus. The manual force will cause the gingival tissue to separate from the tooth and the presence of the cord will prevent the tissue from returning to its original state. In other known methods, two or more separate cords are often required to effect the tissue retraction.

However, known gingival retraction materials and methods are not without their drawbacks. For example, known cords are typically sold in bulk within a dispensing container. Removing the cord from the containers and judging and cutting appropriate lengths can be time-consuming and laborious. To use the cord, the dental practitioner must estimate the amount required for the particular application. This requires the dental practitioner to use both hands, one to dispense the retraction cord from within the dispenser, which is a bulk length cord, and the other to cut the dispensed retraction cord with scissors that are separate from the dispenser. During this process, the dental practitioner must stop working on the patient and is not able to hold other dental instruments; nor is the dental practitioner able to position instruments in the mouth of the patient. The retraction cord must be wrapped around the tooth while the ends are held in one hand by the practitioner; as such, a significant amount of cord is wasted in the process. If the retraction cord is not cut to the appropriate length the retraction cord will not properly retract the gingival tissue and another piece of retraction cord cut to the appropriate length would be needed, further contributing wasted retraction cord to the process. Also, the cord often becomes entangled with itself within the container making removal difficult or even impossible.

If an assistant is assisting the dental practitioner, the dental practitioner will have full use of their hands to continue to work on the patient, but then the dental assistant would not be able to assist the dental practitioner while the dental practitioner is working on the patient. For example, while the dental assistant is using both hands to prepare the retraction cord for the dental practitioner, the dental assistant would not be able to place and hold a saliva ejector, or other instrument, in the patient's mouth. Excess saliva in the mouth of the patient can lead the patient to experience an uncomfortable sensation which could cause the patient to gag, cough or attempt to swallow the saliva.

Thus, a need exists for an improved apparatus for the dispensing of a retraction cord.

### SUMMARY

Disclosed herein is an improved apparatus for dispensing a retraction cord.

In one embodiment, as embodied and broadly described herein, a device is disclosed for dispensing a retraction cord and comprises a housing having a cavity arranged to hold the retraction cord. The dispenser further comprises a knob, handle or button on the dispenser, for example on the top cover or side for use in feeding the cord from the dispenser, an aperture that provides an outlet for the retraction cord to exit the housing, and a cutter near the aperture to cut the dispensed retraction cord.

When the cord feeder is a knob on the top cover it is adapted to rotate about an axis, such that rotation of the knob drives the retraction cord through the aperture and out the housing. After a desired length has been dispensed, the dispensed cord can be cut by operating the cutter.

These and other aspects and advantages of the invention will become apparent from the following detailed description and the accompanying drawings which illustrate by way of example the features of the invention.

### BRIEF DESCRIPTION OF THE DRAWINGS

FIG. 1 is a perspective view of an embodiment of the dispenser according to the invention.

FIG. 2 is a first (right) end view of the dispenser of FIG. 1.

FIG. 3 is a first (front) side view of the dispenser of FIG. 1.

FIG. 4 is top view of the internal components of the dispenser of FIG. 1.

FIG. 5 is a perspective view of the knob showing portions which extend into the internal portion of the dispenser.

FIG. 6 is a view of the lower surface of the top cover.

FIG. 7 is a top view of the dispenser of FIG. 1.

FIG. 8 is a bottom view of the dispenser of FIG. 1

FIG. 9 is a second (left) end view of the dispenser of FIG. 1

FIG. 10 is a second (back) side view of the dispenser of FIG. 1

### DETAILED DESCRIPTION

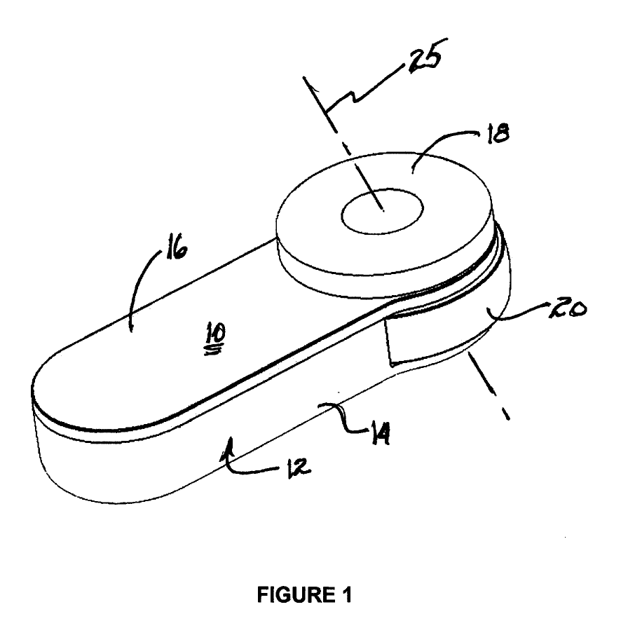

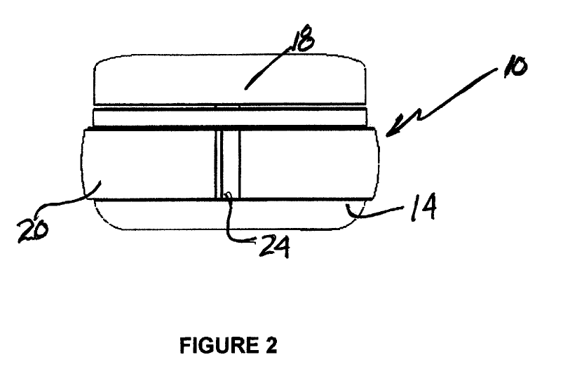

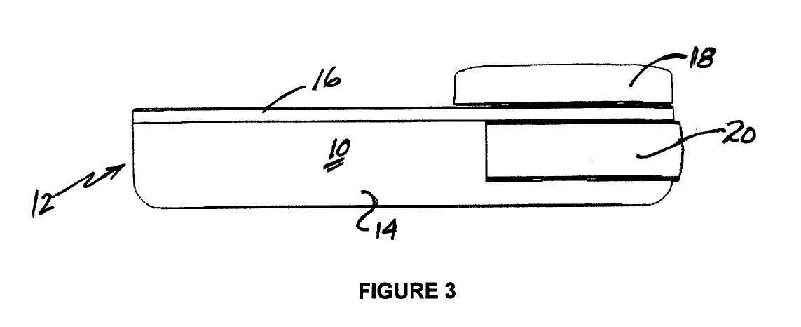

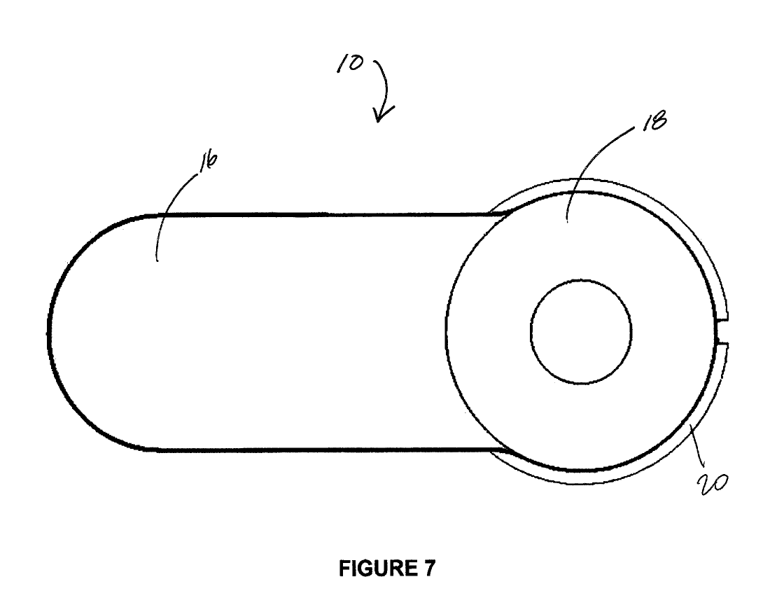

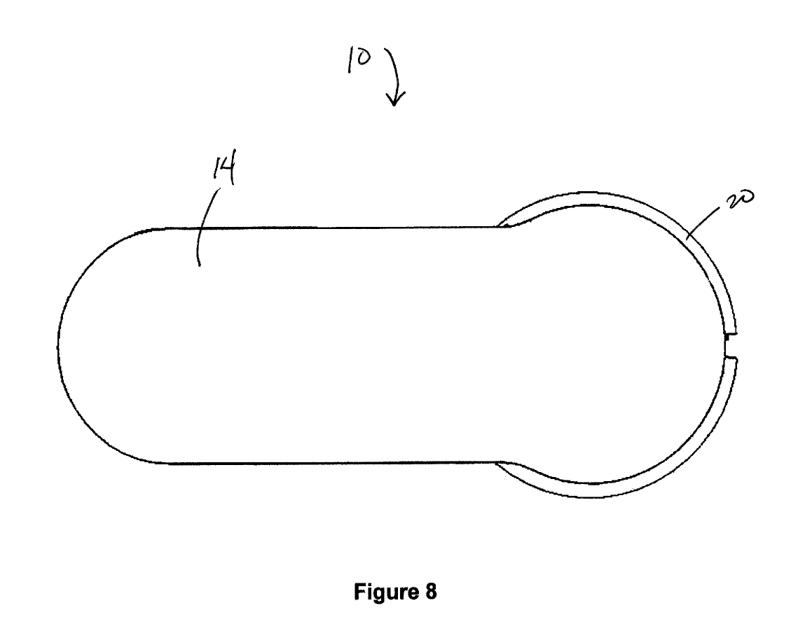

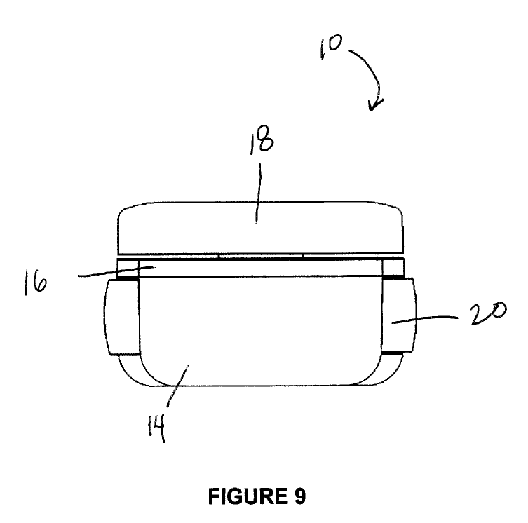

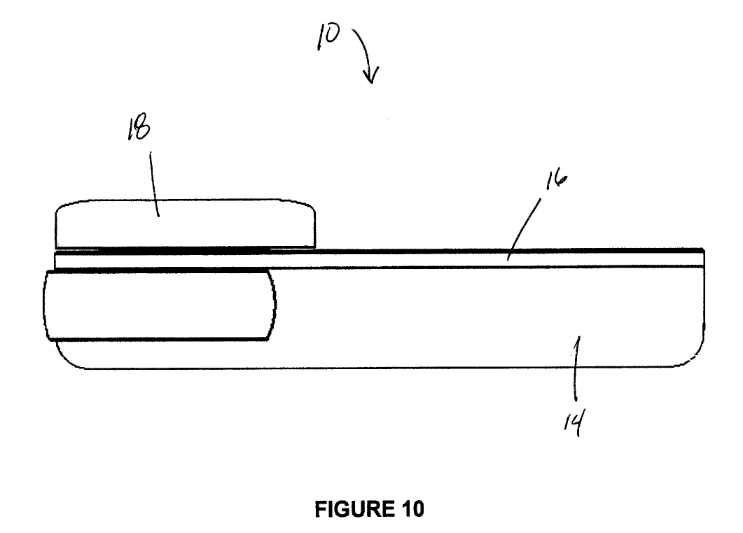

An embodiment described below comprises a device for dispensing a string-like material, referred to herein as a dental cord for use, for example, for gingival retraction. It is understood, however, that the present invention can be used for dispensing many different string like materials, as well as other materials. The term cord is selected for description purposes but also includes a braid, twist, knit, crochet or other similar string-like structures. Referring to FIGS. 1-4 a dispenser 10 incorporating features of the invention includes a housing 12, a knob 18, a cutter 20 and an aperture 24. The housing 12 further comprises a bottom cover 14, a top cover 16 and a cavity 26. The cavity 26 is arranged to house the internal components of the dispenser 10, which are discussed below. FIGS. 7-10 are additional views of FIG. 1.

It is to be understood that when an element or component is referred to as being “on” another element or component, it can be directly on the other element or intervening elements may also be present. Furthermore, relative terms such as “between”, “within”, “adjacent” and “below”, and similar terms, may be used herein to describe a relationship of one element or component to another. It is understood that these terms are intended to encompass different orientations of the device in addition to the orientation depicted in the figures.

Although the terms first, second, etc. may be used herein to describe various elements or components, these elements or components should not be limited by these terms. These terms are only used to distinguish one element or component from another. Thus, a first element discussed below could be termed a second element without departing from the teachings of the present invention. It is understood that actual systems or fixtures embodying the invention can be arranged in many different ways with many more features and elements beyond what is shown in the figures.

FIG. 1 discloses an embodiment of the invention wherein the knob 18 is rotatably mounted on the housing 12. The knob 18 has a central axis 25 and is adapted to rotate about the central axis 25. Rotation of the knob 18 about its central axis 25 dispenses an amount of dental cord 30 through the aperture 24 and in proximity to the cutter 20. Cutter 20 is adapted to cut the dental cord 30 that has been dispensed through aperture 24.

In an embodiment incorporating features of the invention, the knob 18 is adapted to rotate in only one direction and does not rotate in the opposite direction. In such an embodiment, retraction of the dispensed dental cord 30 back into the housing 12 is precluded. Prohibiting the knob 18 from rotating in the opposite direction prevents the dispensed dental cord from being retracted back into the housing 12. It is important to prevent the retraction of the dental cord, such as but not limited to gingival retraction cord, back into the housing 12 because the uncut dispensed dental cord may have become contaminated by contact with bodily fluids of a patient or dental practitioner, or might have been exposed to chemicals or agents used in conjunction with the dental cord. Precluding the retraction of the uncut dispensed dental cord back into the housing 12 reduces the probability of the dental cord within the housing 12 from being contaminated, which, in turn, requires the entire bulk dental cord be discarded.

In a second embodiment, the knob 18 is adapted to rotate in either direction. In this second embodiment, if too much dental cord, such as dental floss, is dispensed by the dispenser 10, then rotation of the knob 18 in the opposite direction will allow the excess dental cord to be retracted back into the housing. However, care must be taken so that the exposed end of the cord is not withdrawn into the dispenser so that a subsequent length cannot be fed therefrom. In a further embodiment, for example, for feeding long lengths of the cord, such as may be desired for delivering dental floss, the device will allow feeding a length of floss which can be grasped by the user so that additional floss can be manually pulled from the dispenser without manually turning the knob 18. In yet other embodiments of the invention, the knob 18 has limited ability to rotate in the opposite direction, and cannot freely rotate in the opposite direction.

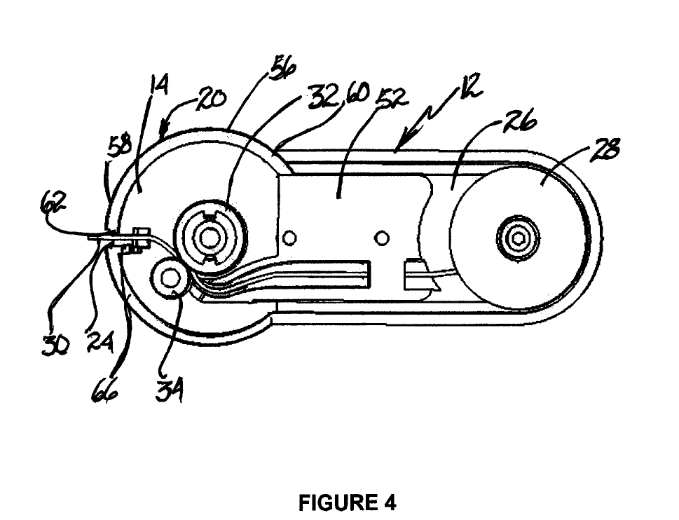

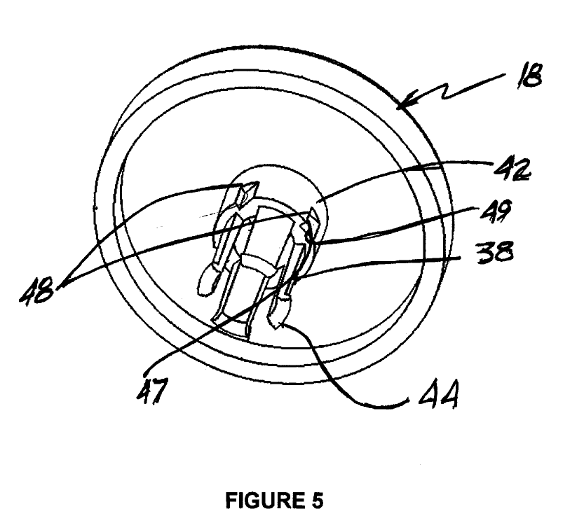

Referring to FIGS. 4 and 5, the knob 18 further comprises a shaft 38, having a first end 42 integral with the knob 18 and a second end 44 which is configured to extend into the housing 12 of the dispenser 10. The shaft 38 extends through an opening 40 of the top cover 16 of the housing 12 and is received by a drive wheel 32 located within the housing 12, such that the knob 18 is rotatably mounted to the housing 12. The drive wheel 32 is positioned on the shaft 38 between the first end 42 and the second end 44, wherein the second end 44 has an attachment device 46, such as finger extensions, which couples the second end 44 of the shaft 38 to mating structure on the drive wheel 32. The first end 42 of the shaft 38 is positioned adjacent to the opening 40 of the top cover 16. Included in the first end 42 of the shaft 38 is at least one structure, such as but not limited to slots or holes 48, the at least one structure preferably having a vertical edge 47 and a sloped edge 49. However, in other embodiments the at least one structure can have many different shapes and/or edges.

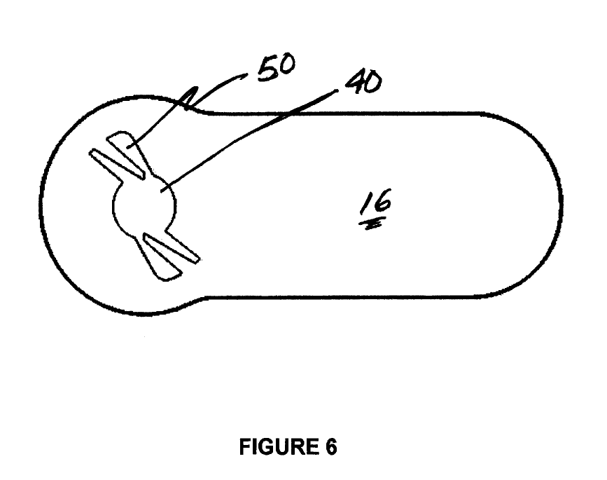

Referring to FIG. 6, the top cover 16 of housing 12 comprises a plurality of extensions 50 adjacent the opening 40 and the first end 42 of the shaft 38. In other embodiments, the housing has at least one extension 50. Each of the plurality of extensions 50 is adapted to engage a structure 48 to allow or prevent rotational movement of the knob 18. In an embodiment where the knob 18 can rotate in only one direction, the knob 18 is maintained in a static position when the extensions 50 contact the sloped edge 49 and the vertical edge 47 of the structure 48. The extensions 50 contacting the vertical edge 47 of the structure 48 prevent rotation of the knob 18 in the opposite direction. When the knob 18 is rotated in the proper direction, the sloped edge 49 of the structure 48 imparts a force on the extensions 50, causing the extensions to become slightly displaced such that the extensions 50 glide along the sloped edge 49 of the structure 48 until the extensions 50 reach the surface of the first end 42 of the shaft 38 not having a structure 48. At this point, the surface of the first end 42 imparts a force on the extensions 50 causing the extensions 50 to maintain their displacement and glide along the surface of the first end 42 of the shaft 38. The extensions 50 remain displaced until the extensions 50 pass the vertical edge 47 of a structure 48. The extensions 50 are then able to return to their non-displaced position and can contact the sloped edge 49 and the vertical edge 47 of the structure 48. In other words, as the knob 18 is turned to dispense the cord the extensions 50 ride along the rotating surface of the first end 42, sliding over the structure 48. However, if the knob 18 is rotated in the opposite direction (i.e., backward) at least one extension will slide into a structure 48 and will contact the vertical edge 47 preventing further backward rotation.

In some embodiments of the invention, there is at least one extension 50, while in other embodiments there is a plurality of extensions 50. Additionally, in some embodiments there is at least one structure 48, while in other embodiments, there are a plurality of structures 48. Furthermore, the structures 48 can be evenly spaced apart or the separation between structures 48 can be varied. When the extensions 50 are gliding on the surface of the first end 42, in between structures 48, or on the sloped edge of the structure 48, the knob 18 has the limited ability to rotate in the opposite direction. Further rotation in the opposite direction is precluded upon the extensions 50 contacting the vertical edge of the structure 48.

As shown in FIG. 4, the housing 12 has a cavity 26 which is arranged to house the internal components of the dispenser 10. The internal components housed within the cavity comprise a spool 28 of bulk dental cord 30, a drive wheel 32, a second wheel 34 and a bracket 52. The bracket 52 has a spool extension 54 upon which the spool 28 is rotatably mounted and a conduit 36. The spool extension 54 is adapted to receive the spool 28 of bulk dental cord 30. The conduit 36 provides a pathway between the spool 28 and the aperture 24 for the dental cord 30. The dental cord travels along the conduit 36 as it is being fed from the dispenser 10 by rotation of the knob 18. The dental cord which has been unwound from the spool 28, prior to delivery through the aperture 24 is housed within conduit 36 when the dispenser 10 is not in use.

The drive wheel 32 is in frictional contact with the second wheel 34 and the dental cord 30 so that the dental cord 30 positioned therebetween is fed in response to rotation of the drive wheel 32. The drive wheel 32, which rotates about the same central axis as the knob 18, is attached to the shaft 38 so that the drive wheel 32 rotates in the same direction as the knob 18. The dental cord from the spool 28 is positioned within the conduit 36 and is in contact with both the drive wheel 32 and the second wheel 34. When the knob 18 is rotated in the direction to dispense the dental cord, the rotation of the drive wheel 32 causes the dental cord to be driven towards the aperture 24. Interposing the dental cord between the drive wheel 32 and the second wheel 34 allows the drive wheel 32 to impart a force on the dental cord such that the dental cord is driven in relation to the rotation of the knob 18. In the embodiments where the knob 18 can rotate in the opposite direction, such rotation causes the drive wheel 32 to impart a force on the dental cord in the opposite direction to retract the dental cord into the housing 12. The second wheel 34 is positioned adjacent the drive wheel 32 to provide a surface opposite the drive wheel 32. This configuration ensures that the dental cord remains interposed between the drive wheel 32 and the second wheel 34, and allows the drive wheel 32 to impart a force on the dental cord to drive the dental cord towards the aperture 24, or to retract the dental cord in such embodiments where the knob 18 is configured to rotate in the opposite direction.

One skilled in the art will recognize based on the teachings herein that means other than the drive or second wheels can be used to advance the cord. For example, the cord in the channel can be grasped by an internal clamping means which is then moved linearly forward to feed a length of cord out the aperture, this grasp and feed procedure repeated to provide additional lengths.

The cutter 20 comprises a cutter body 56 having a cutter first end 58 and a cutter second end 60, the cutter body 56 being preferentially attached to the bracket 52 at the cutter second end 60. In the embodiment shown in the figures, the cutter body 56 has a curved shape between the cutter first end 58 and the cutter second end 60. In other embodiments, the cutter body 56 can have different shapes and is not limited to a curved shape. The cutter first end 58 terminates adjacent the aperture 24 and has a cutting edge 62 attached to the end thereof. The bottom cover 14 of the housing 12 has a cut-out portion (not shown) which is adapted to receive the cutter 20.

The cutter 20 is adapted to cut the dispensed dental cord 30 at the aperture 24 in order to separate the dental cord from the dispenser 10. To operate the cutter 20, pressure is applied to the cutter body 56 to cause the cutting edge 62 to contact the dispensed dental cord 30 at the aperture 24. Prior to operating the cutter 20, the dispensed dental cord is interposed between the cutting edge 62 and a vertical edge 66 of the bottom cover 14 of the housing 12. When pressure is applied to the cutter 20 the cutter body 56 slides along the outer surface of the cover 14, the cutting edge 62 contacts the dental cord 30 positioned in the aperture 24 and presses the dental cord against the vertical edge 66 of the bottom cover 14 by the cutting edge 62. The pressure applied to the cutter body 56 is sufficient to cause the cutting edge 62 to cut the dental cord when pressed up against the vertical edge 66 of the bottom cover 14.

Based on the teachings herein, one skilled in the art will recognize that the described device provides to the user the ability to dispense a desired length of cord.

The dispenser 10 is configured such that it can be operated by a user using a single hand. For example, the user can hold the dispenser 10 in their hand and rotate the knob 18 using a finger, for example the thumb. The knob 18 is rotated using the finger until the desired amount of dental cord is dispensed. The user may than use the same finger used to rotate the knob 18 to operate the cutter 20. The user, while applying constant pressure to the cutter 20, can then position the dispenser 10 in proximity to their other hand or another person such that the dispensed dental cord is grasped and separated from the dispenser 10. The dispenser 10 is configured to ease the process of removing bulk dental cord from its container. Additionally, the knob 18 is configured such that a rotation between structures 48 dispenses a predetermined amount of dental cord. This eliminates the guesswork needed in dispensing dental cord from bulk containers. Different embodiments can dispense different lengths of cord per rotation of the knob 18, with some embodiments dispensing cord in the range ½ to 3 inches of cord per knob rotation, while other embodiments can dispense cord in the range of 1 to 2 inches of cord per knob rotation. In still other embodiments, approximately 1½ inches of cord can be dispensed per knob rotation. The dispenser can also comprise notch or detent arrangement that the knob 18 interacts with as it rotates, with the user being able to feel the notch interaction as the knob 18 is rotated. This interaction allows the user to feel the amount of rotation by feeling the interaction with the notches, with different notches in different embodiments arranged to allow the user to feel a full rotation, half rotation, quarter rotation, or even smaller amounts of rotation. The dispenser 10 having an integrated cutter 20 also eliminates the need to have to use both hands in order to dispense the dental cord because the same hand can be used to dispense and cut the dental cord; whereas in current practice, one hand is needed to hold the dental cord dispensed from its container and another hand to operate the scissors to cut the dispensed dental cord.

The dispenser shown in the figures can be made of plastic, but is not intended to be limited to plastic. The dispenser can also be made of various different materials such as, but not limited to, wood, paper, metal, or combinations thereof. In some embodiments of the invention, the cutting edge 62, such as but not limited to a blade, of cutter 20 is not replaceable; whereas in other embodiments, the cutting edge 62 is disposable and can be replaced with a new cutting edge. The cutting edge 62 is fabricated from materials typically used for knives, scalpels, i.e., carbon steel, stainless steel, ceramics, etc., corrosion resistant materials being preferred for cords which include various medicaments. In some embodiments of the invention, the dispenser 10 is configured such that the housing 12 cannot be opened in order to place a replacement spool 28 of dental cord when all the dental cord has been dispensed. In other embodiments, the housing 12 can be opened and refilled with a replacement spool 28 in order to reuse the dispenser 10.

The present invention is described herein with reference to certain embodiments, but it is understood that the invention can be embodied in many different forms and should not be construed as limited to the embodiments set forth herein. For example, the embodiments herein show a manually rotated knob. However, alternate cord advancing mechanisms can be used such as a lever or a push button operated spring driven arrangement. Still further, dispensing from the spool can be accomplished by a battery or gas powered drive actuated by a button or lever, the drive rotating the drive wheel 32 or the drive wheel 34. Still further, it is not required that the cord be on a spool. In an alternate embodiment, the cord is wound on a rod which is placed in the dispenser, or the cord can be loosely placed in a chamber located within the dispenser, no spool or rod being present. In a like manner the cutting function can also utilize a battery, spring or gas driven cutting blade. While the primary purpose of the dispenser is to dispense a retraction cord, one skilled in the art will recognize it has utility as a dispenser for other cords or string-like materials, such as dental floss, or in non-dental applications as a dispenser and cutter for packaging string or twist ties for plastic bags.

We claim:

1. A device for dispensing a cord, comprising:
a housing;
a rotatable knob on said housing;
an aperture in said housing;
a cutting device adjacent said aperture, and
a cord housed within said housing with an end thereof extending through said aperture, said cutting device adapted to cut said cord extending from said housing.

2. The device of claim 1, wherein said housing comprises a top cover and a bottom cover coupled together to form a cavity therebetween.

3. The device of claim 2, wherein said cavity houses internal components adapted for delivery of said cord towards and through said aperture.

4. The device of claim 1, wherein said knob is rotatably mounted onto said top cover.

5. The device of claim 4, wherein said knob is operatively connected to the cord and the knob is configured such that rotation thereof causes said cord to move outward through said aperture.

6. The device of claim 4, wherein said knob has a shaft extending into said housing, said shaft connected to a drive wheel within said housing.

7. The device of claim 6, wherein said top cover of said housing includes an extension adapted to engage said shaft to prevent rotation of said knob in an unintended direction.

8. The device of claim 1, wherein said cutting device comprises a body having a first end extending across said aperture and a second end mounted to said housing.

9. The device of claim 8, wherein said first end of said body comprises a cutting surface.

10. A device for dispensing a cord, comprising:
a housing;
a plurality of internal components enclosed within said housing;
a rotatable knob on said housing and integral with at least one of said plurality of internal components;
an aperture in said housing;
a cutting device mounted on said housing adjacent said aperture, a portion thereof extending into the aperture, and
a cord housed within said housing, an end thereof extending through said aperture, said cord operatively connected to at least one of said internal components.

11. The device of claim 10, wherein said housing comprises a top cover and a bottom cover assembled to enclose said plurality of internal components and said cord.

12. The device of claim 10, wherein said internal components comprise:
a bracket,
a drive wheel mounted on said bracket, and
a second wheel driven by said drive wheel.

13. The device of claim 12, wherein said cord is rotatably mounted onto an extension from said bracket.

14. The device of claim 12, wherein said drive wheel is in frictional contact with said second wheel and said cord, such that rotation of said drive wheel causes said cord to further extend from said housing.

15. The device of claim 10, said cutting device further comprising a first end and a second end, wherein said second end is mounted to said housing and said first end comprises a cutting edge extending into the aperture.

16. The device of claim 10, wherein said cutting device is configured to cut said cord.

17. The device of claim 12, said knob having a shaft rotatable within said housing, said shaft integral with said drive wheel.

18. The device of claim 17, wherein said housing comprises at least one extension and said shaft has at least one structure on or in a surface thereof, wherein said at least one extension is adapted to contact said at least one structure such that said at least one extension is configured to prevent rotation of said knob in an unintended direction when contacting said structure.

19. The device of claim 17, wherein said knob is adapted to rotate said shaft within the housing, such that rotation of said knob and shaft imparts a rotational force on said drive wheel.

20. The device of claim 19, wherein rotational movement of said knob causes the cord to dispense from said housing.

21. The device of claim 14, wherein said knob is further adapted to rotate in a rearward direction to retract cord into said housing.

22. The device of claim 16 wherein the cutting device is further configured to slide on the housing to cut the cord.

23. A device for dispensing a string like material, comprising:
a housing holding a string like material;
a hand operable extension mechanism integral to said housing for causing a string like material to extend from said housing; and
a hand operable cutting device for cutting said string like material, wherein said extension mechanism and cutting device are arranged such that they are operable with a single hand.
